(19) United States
(12) Patent Application Publication
(10) Pub. No.: US 2003/0061079 A1
(43) Pub. Date: Mar. 27, 2003

(54) Menu update of telematic services in a vehicle

(76) Inventors: Gerd Noghero, Blaustein (DE); Mathias Raithel, Grafenau (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/226,233

(22) Filed: Aug. 23, 2002

(30) Foreign Application Priority Data
Aug. 24, 2001 (DE) 101 41 625.3-32

(51) Int. Cl. G06F 17/60

(52) U.S. Cl. 705/5

(57) ABSTRACT

A process for the menu update and use of telematic services in a vehicle by way of an external service providing center. Data is exchanged between the vehicle and the service providing center with the service providing center providing telematic services. A menu for telematic services is provided by means of an information system of the vehicle, and the telematic services are selectable by way of the menu of the information system. The menu updating of the terminal takes place by the service providing center independently of the menu entry at the terminal. In addition, when updating and using telematic services, the data transmission between the service providing center and the vehicle is to be minimized. Subsequently, the service providing center is given access to a documentation system in which, by means of the vehicle identification tagging, information is filed concerning the equipment of the vehicles.

This application claims the priority of German Application No. 101 41 625.3-32, filed Aug. 24, 2001, the disclosure of which is expressly incorporated by reference herein.

### BACKGROUND AND SUMMARY OF THE INVENTION

The invention relates to a process for the menu update and use of telematic services in a vehicle by way of a service providing center.

Telematic services provide so-called added value to a vehicle. These services are offered in the vehicle by way of a menu that can be activated from the vehicle. With these services, the driver can, for example, initiate the sending of brochures to his address or the finding of the nearest repair shop or the nearest hotel. The vehicle manufacturers provide these services through service providing centers which communicate with the vehicle by wireless data transmission. Since these added-value services are still being created and a plurality of use possibilities are already being considered, considerable ongoing developments in this field are expected. These services are not available to all vehicles, but it has to be ensured that the services are offered in vehicles according to certain criteria, for example, according to the manufacturer, the vehicle, the owner.

From German Patent Document DE 196 40 735 A1, a telematic unit for a motor vehicle is known by means of which generally relevant information can be received via the car radio and individual information can be received by way of the GSM-module. Furthermore, by means of the disclosed telematic unit, for example, data concerning the vehicle position, a desired destination or an emergency call can be sent to the center. The center computes one or several destination routes and sends these back to the telematic unit. In the event of an accident or a car breakdown, a corresponding emergency call is sent and help is summoned. Expanded theft protection for the motor vehicle, hotel reservations, etc. are provided as additional telematic services obtained from the telematic unit.

From German Patent Document DE 196 25 002 A1, a vehicle communication system is known which has a central computer for the implementation of telematic applications, equipment units for processing data pertaining to telematic applications and one or several data transmission channels with the pertaining interfaces. The equipment units can be connected with the central vehicle computer by way of the interfaces. In this case, the equipment units are assigned to the different telematic applications in a flexibly controllable manner. An adaptive application control is provided which, in order to implement a respective application, selects the respectively required equipment units relative to their functions.

European Patent Document EP 891 111 A2 discloses a process for the configuration, particularly the clearing, of a terminal for the utilization of services of a service providing center. Certain information, defined by the service providing center, must be entered in the terminal in order to activate the services. In this process, no updates of the menu entries are carried out in the terminal.

European Patent Document EP 911 607 A2 discloses a process and a system for updating the menu of a mobile terminal. With this process, the mobile terminal has to first contact the center in order to query the version information from the center. An update can take place only after a comparison of the version information from the center with that of the mobile terminal. Only menus with different versions are updated. In this process, the updating operation must be initiated by several communication steps between the center and the terminal, which involves additional data traffic. In addition, the terminal must cyclically inquire at the center whether an updating is required.

It is now an object of the present invention to further develop the described process such that the menu update of the terminal takes place by means of the service providing center independently of the menu entry at the terminal. In addition, the data transmission between the service providing center and the vehicle is to be minimized during the updating and use of telematic services.

According to the invention, the service providing center is given access to a documentation system in which information is filed concerning the equipping of the vehicles by means of vehicle identification tagging. The telematic services for the vehicle which can be operated from a vehicle are compiled by way of the service providing center by means of the information in the documentation system in an up-to-date manner with respect to the vehicle.

The vehicle identification tagging corresponds to an unambiguous tagging of the vehicle. Generally, the chassis number (Vehicle Identification Number) of the vehicle is used. However, it may also be the license number or the identity of the vehicle holder.

By means of the process, the service providing center can determine whether or which terminals have to be updated in the respective vehicles because the service providing center compiles information by means of the documentation system. In addition, menus with different menu entries are conceivable since these can be individually compiled for each vehicle.

In a further development of the process according to the invention, the menu consisting of the information for the individual telematic services is transmitted from the external service providing center to the vehicle. The menu for telematic services in the vehicle is updated by means of the information system, in which case the complete existing telematic service entries are replaced by the telematic service entries compiled by the service providing center.

This eliminates data traffic for determining whether or not the entry for the telematic service has to be updated. The process also ensures that the telematic service menu in the vehicle is controlled exclusively by the service providing center.

The process according to the invention can advantageously be further developed so that the data to be transmitted from the service providing center to the vehicle is minimized because the information for a telematic service is limited to the essential information. Thus, the information for an telematic service consists only of a descriptive text and an identification code. Since only a submenu is used, no additional information is required for the menu positioning.

Different possibilities exist for advantageously developing the teaching of the present invention. For this purpose, reference is made to the following explanation of an embodiment.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic view of a system for implementing the process according to the invention; and

FIG. 2 is a schematic view of a menu which is displayed in the vehicle when the process according to the invention is applied.

### DETAILED DESCRIPTION OF THE PREFERRED EMBODIMENT

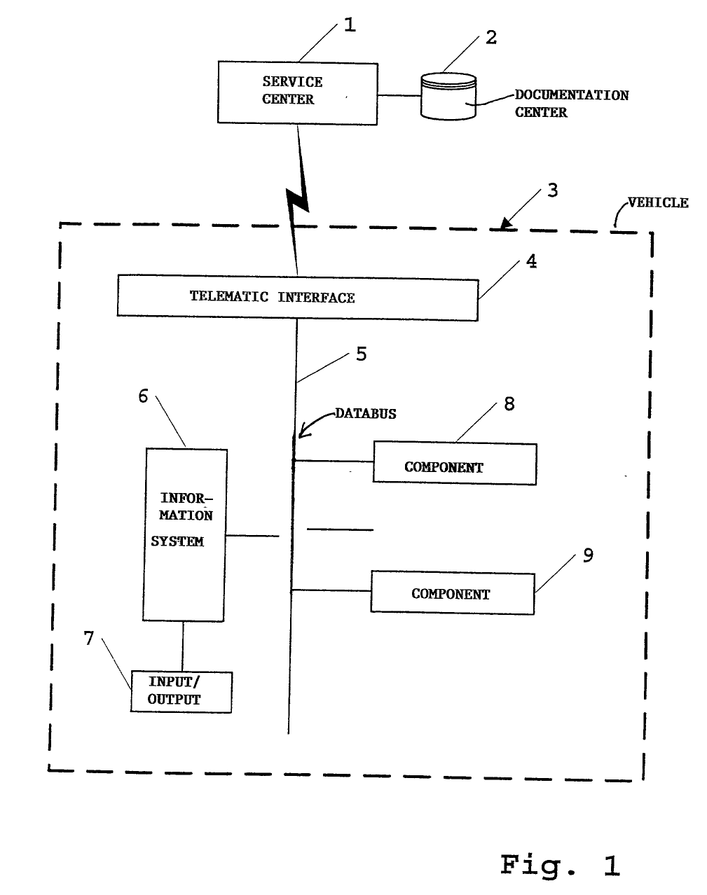

The system according to the invention is illustrated in FIG. 1. The service providing center 1 is connected with a documentation system 2. For reasons of product liability and maintenance, all electronically available data concerning the vehicles 3, particularly their equipment, vehicle type and vehicle holder, are filed in the documentation system. The assignment of the data to the vehicle 3 takes place by way of the chassis number which therefore corresponds to the vehicle identification tagging.

The service providing center 1 offers different telematic services. However, not all telematic services are to be made available to all vehicles. For example, because of the purchasing price, a larger number of telematic services are to made available to higher-value vehicles, whereas no services or only very few services are offered to vehicles with low-value equipment.

For this reason, by means of the information existing in the documentation system 2, the service providing center 1 compiles the telematic services which can be activated for a vehicle 3 individually in a vehicle related manner in a menu. The service providing center 1 sends these data for the telematic service menu consisting of the information concerning the individual telematic service defined for the vehicle to the vehicle 3. The vehicle 3 is unambiguously identified by its chassis number (Vehicle Identification Number), so that the service providing center 1 can establish a connection by means of the information, such as the telephone number, filed for the vehicle 3 in the documentation system 2.

The service providing center 1 can repeat this process at any time, preferably when the service providing center 1 makes new or updated telematic services available. The complete menu, and thus all telematic services made available to the vehicle 3, are always sent to the vehicle 3 in order to avoid unnecessary data traffic between the service providing center 1 and the vehicle 3. The data traffic for determining whether or not the entry for the telematic service has to be updated is therefore eliminated. In addition, it is ensured by means of the process that the telematic service menu in the vehicle 3 is controlled exclusively by the service providing center 1.

The service providing center 1 preferably exchanges data concerning a wireless transmission device by means of the communication interface 4 with the vehicle 3. By way of a data bus system 5, the communication interface 4 is connected with the information system 6 and additional components 8, 9. The information system 6 has an input/output unit 7 for the display and activation of menus or menu entries.

The information sent by the service providing center 1 for the telematic services consists of a descriptive text, for example, of “brochures”, and of an identification code for this service which is issued by the service providing center. The identification code generally consists of an alphanumeric tagging and is used for differentiating between the services offered by the service providing center.

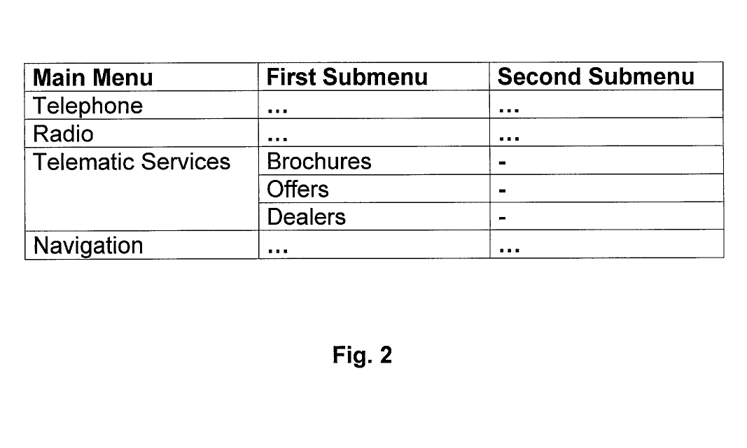

The information system 6 integrates this information into the “Telematic Services” menu item. FIG. 2 displays a schematic representation of a menu having several hierarchical protocol layers, as displayed by means of the input/output unit 7 of the information system 6. In the main menu, the “telematic services” menu point can be selected which consists only of a submenu. In this submenu, the information related to the sent telematic services, such as “brochures”, “offers” and “dealers” is filed. These telematic services can be activated by way of the input/output unit 7. The identification code of the telematic service is filed in the information system 6. It is not displayed in the menu because it is not descriptive.

The data to be transmitted from the service providing center 1 to the vehicle 3 are minimized in that the information for a telematic service is limited to the most essential information. Thus, the information of a telematic service consists only of a descriptive text and an identification code. Since only a submenu is used, no additional information is required for the positioning of the menu.

When a telematic service is now activated by an occupant of the vehicle 3 by means of the input/output unit 7 of the information system 6, the information system 6 will send the identification code for the selected telematic service provided with the chassis number to the service providing center 1 by means of the communication interface 4. This service providing center then activates the selected service for the vehicle 3 with the corresponding chassis number. Should the service providing center 1 require additional information for performing the service, such as the vehicle holder's address, it can determine this information by means of the chassis number by way of the documentation system 2. A telematic service, such as “brochures”, which, when activated, sends the newest brochures concerning the vehicle 3 to the vehicle holder's address, can take place by means of minimal data traffic between the vehicle 3 and the service providing center 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A process for menu update and use of telematic services in a vehicle by an external service providing center, said process comprising the steps of:
exchanging data between the vehicle and the service providing center,
providing telematic services by the service providing center,
providing a menu for telematic services by means of an information system of the vehicle,
selecting particular ones of said telematic services by way of the menu of the information system,
providing the service providing center with access to a documentation system in which information concerning the equipment of the vehicles is filed by means of vehicle identification tagging, and
compiling, in the service providing center, the telematic services for a vehicle to be operated from the vehicle by means of updated information accessed from the documentation system.

2. The process according to claim 1, wherein the step of selecting includes:
transmitting the menu consisting of the information for the individual telematic services by the external service providing center to the vehicle, and the step of providing a menu includes
updating the menu for telematic services in the vehicle by means of the information system with the complete telematic service entries already existing being replaced by the telematic service entries compiled by the service providing center.

3. The process according to claim 1, wherein, when a telematic service is activated, the identification code of the telematic service together with the vehicle identification number are sent to the service providing center so that the service providing center can determine the recipient of the service.

4. The process according to claim 1, wherein
the menu for telematic services in the vehicle consists only of a hierarchical step, and
the information for the individual telematic services to be transmitted to the vehicle is composed of the identification code as well as a text describing the telematic service.

5. The process according to claim 1, wherein the service providing center controls, by means of the information system, whether or not a driver receives information concerning the implemented updating of the telematic service menu.

6. The process according to claim 2, wherein, when a telematic service is activated, the identification code of the telematic service together with the vehicle identification number are sent to the service providing center so that the service providing center can determine the recipient of the service.

7. The process according to claim 2, wherein
the menu for telematic services in the vehicle consists only of a hierarchical step, and
the information for the individual telematic services to be transmitted to the vehicle is composed of the identification code as well as a text describing the telematic service.

8. The process according to claim 3, wherein
the menu for telematic services in the vehicle consists only of a hierarchical step, and
the information for the individual telematic services to be transmitted to the vehicle is composed of the identification code as well as a text describing the telematic service.

9. The process according to claim 2, wherein the service providing center controls, by means of the information system, whether or not a driver receives information concerning the implemented updating of the telematic service menu.

10. The process according to claim 3, wherein the service providing center controls, by means of the information system, whether or not a driver receives information concerning the implemented updating of the telematic service menu.

11. The process according to claim 4, wherein the service providing center controls, by means of the information system, whether or not a driver receives information concerning the implemented updating of the telematic service menu.

12. An improved process for using telematic services delivered by an external service provider for a vehicle, said method comprising the steps of:
providing a documentation system containing information concerning equipment of a plurality of vehicles with each of said vehicles being identified by a vehicle identification tag;
accessing said information in said documentation system by said external service provider;
compiling, in the external service provider telematic services which are operated from the vehicle by means of updated information from said documentation system for said vehicle to be operated.

13. The process according to claim 12, further including a step of providing a menu for said telematic services by means of an information system in said vehicle and selecting particular ones of said telematic services from said menu.

14. The process according to claim 12, wherein the step of selecting includes transmitting the menu consisting of the information for individual telematic services by the external service providing center to the vehicle.

15. The process according to claim 13, wherein the step of providing a menu includes updating the menu for telematic services in the vehicle by means of the information system with the complete telematic service entries already existing being replaced by telematic services entries complied by the service providing center.

16. The process according to claim 12, wherein when a telematic service is activated, the identification code of the telematic service together with the vehicle identification number are sent to the service providing center so that the service providing center can determine the recipient of the service.

17. The process according to claim 12, wherein
the menu for telematic services in the vehicle consists only of a hierarchical step, and
the information for the individual telematic services to be transmitted to the vehicle is composed of the identification code as well as a text describing the telematic service.

18. The process according to claim 12, wherein the service providing center controls, by means of the information system, whether or not a driver receives information concerning the implemented updating of the telematic service menu.
